(19) United States
(12) Patent Application Publication
(10) Pub. No.: US 2012/0204540 A1
(43) Pub. Date: Aug. 16, 2012

(54) POWER SYSTEM AND METHOD FOR ENERGIZING AN ELECTRICALLY HEATED CATALYST

(75) Inventors: Eugene V. Gonze, Pinckney, MI (US); Michael J. Paratore, JR., Howell, MI (US)

(73) Assignee: GM GLOBAL TECHNOLOGY OPERATIONS LLC, Detroit, MI (US)

(21) Appl. No.: 13/026,569

(22) Filed: Feb. 14, 2011

(51) Int. Cl. F01N 3/18; H02J 1/00

(52) U.S. Cl. 60/274; 307/78

(57) ABSTRACT

A power system and a method for energizing an electrically heated catalyst are provided. The system includes a first battery outputting a first voltage, and a second battery outputting a second voltage. The system further includes a switching device having a first operational state where the first and second batteries are coupled in series to one another, and a second operational state where the first and second batteries are coupled in parallel to one another. The system further includes a generator coupled to the first battery, and when the switching device is in the second operational state the generator supplies a third voltage to the first battery to charge the first and second batteries, and to the electrically heated catalyst such that the catalyst heats exhaust gases upstream of an oxidation catalyst.

### FIELD OF THE INVENTION

Exemplary embodiments of the invention relate to a power system and a method for energizing an electrically heated catalyst in a vehicle.

### BACKGROUND

Internal combustion powered vehicles have utilized an electrically heated catalyst in an exhaust system. The electrically heated catalyst is energized via a 12 volt battery of the motor vehicle. Also, a vehicle electrical system includes a generator that supplies a voltage to the battery and electrical loads on the motor vehicle along with the electrically heated catalyst. In order to heat the electrically heated catalyst to an operating temperature, high power levels are needed. If the electrically heated catalyst is energized only from the vehicle battery, the relatively high current levels required to heat the catalyst may result in a reduced operational life of the battery. Also, if the vehicle battery is taken off-line (i.e., temporarily disconnected from a generator) during a time period for heating the electrically heated catalyst, vehicle loads connected to the vehicle battery may significantly reduce the stored energy in the battery.

### SUMMARY OF THE INVENTION

In an exemplary embodiment of the invention, a power system for energizing an electrically heated catalyst is provided. The electrically heated catalyst is disposed upstream of an oxidation catalyst. The power system includes a first battery configured to output a first voltage, and a second battery configured to output a second voltage. The power system further includes a switching device coupled between the first and second batteries. The switching device has a first operational state such that the first and second batteries are coupled in series to one another, and the switching device has a second operational state such that the first and second batteries are coupled in parallel to one another. The power system further includes a generator coupled to the first battery, and when the switching device is in the second operational state the generator supplies a third voltage to the first battery to charge the first and second batteries, and supplies the third voltage to the electrically heated catalyst such that the electrically heated catalyst heats exhaust gases upstream of the oxidation catalyst.

In another exemplary embodiment of the invention, a method for energizing an electrically heated catalyst is provided. The electrically heated catalyst is disposed upstream of an oxidation catalyst. The method includes generating a first signal to induce a switching device to transition from a first operational state where first and second batteries are coupled in parallel to one another to a second operational state where the first and second batteries are coupled in series to one another, utilizing a controller. The method further includes supplying a voltage from a generator to the first battery to charge the first and second batteries, and supplying the voltage to the electrically heated catalyst to induce the electrically heated catalyst to heat exhaust gases upstream of the oxidation catalyst, when the first and second batteries are connected in series to one another.

The above features and advantages, and other features and advantages of the invention are readily apparent from the following detailed description of the invention when taken in connection with the accompanying drawings.

### BRIEF DESCRIPTION OF THE DRAWINGS

Other objects, features, advantages and details appear, by way of example only, in the following detailed description of the embodiments, the detailed description referring to the drawings in which:

FIG. 1 is a schematic view of a power system for energizing an electrically heated catalyst in accordance with an exemplary embodiment of the invention;

FIG. 2 is a flow diagram of a method for energizing an electrically heated catalyst in accordance with another exemplary embodiment of the invention; and

FIG. 3 is a schematic of a switching device utilized in the power system of FIG. 1.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

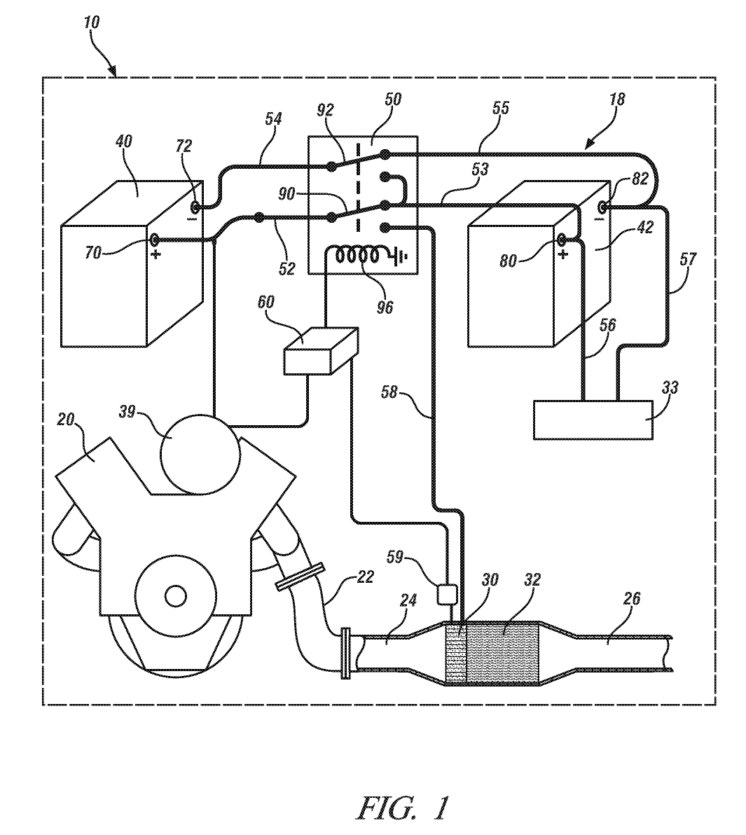

Referring to FIG. 1, a vehicle 10 having a power system 18 for energizing an electrically heated catalyst 30 in accordance with an exemplary embodiment is provided. The vehicle 10 further includes an engine 20, exhaust pipe sections 22, 24, 26, the electrically heated catalyst 30, an oxidation catalyst 32, and vehicle electrical loads 33.

The engine 10 is provided to supply mechanical power for movement of the vehicle 10. The engine 10 produces exhaust gases that flow through the exhaust pipe sections 22, 24, the electrically heated catalyst 30, the oxidation catalyst 32, and the exhaust pipe section 26. As shown, the exhaust pipe section 22 is coupled to both the engine 20 and the exhaust pipe section 24. Also, the electrically heated catalyst 30 is coupled to both the exhaust pipe section 24 and the oxidation catalyst 32. Finally, the exhaust pipe section 26 is coupled to the oxidation catalyst 32. When the electrically heated catalyst 30 is energized, the catalyst 30 is heated by an electrical current flowing therethrough such that an oxidation of excess carbon monoxide (CO) and hydrocarbons (HC) occurs in the catalyst 30 to further increase a temperature of the catalyst 30 and a temperature of exhaust gases flowing through the catalyst 30. The carbon monoxide (CO) and hydrocarbons (HC) in the exhaust gases are then further oxidized in the oxidation catalyst 32.

The power system 18 is provided to energize the electrically heated catalyst 30 and to electrically charge a first battery 40 and a second battery 42. The power system 18 includes a generator 39, the first battery 40, the second battery 42, the switching device 50, conductors 52, 53, 54, 55, 56, 57, 58, a temperature sensor 59, and a controller 60.

The generator 39 is configured to generate a voltage (e.g., a DC voltage) that is received at the first positive terminal 70 of the first battery 40. In particular, the generator 39 generates an AC voltage when the engine 20 turns a rotor of the generator 39, and then the generator 39 utilizes an internal voltage regulator to convert the AC voltage to a DC voltage that is applied to the terminal 70. In one exemplary embodiment, the generator 39 outputs a DC voltage that is adjustable by control signals from the controller 60, within a range of 0-24 volts for example. In one exemplary embodiment, the generator 39 outputs 24 volts DC when energizing the electrically heated catalyst 30.

The first battery 40 has a first positive terminal 70 and a first negative terminal 72 and is configured to output a first voltage, such as 12 volts for example, between the terminals 70, 72. The second battery 42 has a second positive terminal 80 and a second negative terminal 82 and is configured to output a second voltage, such as 12 volts for example, between the terminals 80, 82. Of course, in an alternative embodiment, the first battery 40 and the second battery 42 could output voltages less than 12 volts or greater than 12 volts.

The switching device 50 is coupled between the first and second batteries 40, 42. The switching device 50 has a first operational state (shown in FIG. 1) such that the first and second batteries 40, 42 are coupled in series to one another. Also, the switching device 50 has a second operational state (shown in FIG. 3) such that the first and second batteries 40, 42 are coupled in parallel to one another. In one exemplary embodiment, the switching device 50 is a double-pole double-throw relay device and includes first and second switches 90, 92 that are actuated between the first and second operational positions by energization and de-energization of an internal coil 96, respectively.

The conductor 52 is coupled between the switch 90 and the first positive terminal 70, and the conductor 54 is coupled between the switch 92 and the first negative terminal 72. Also, the conductor 53 is coupled to the second positive terminal 80 and selectively coupled to the switch 90, and the conductor 55 is coupled to the second negative terminal 82 and the selectively coupled to the switch 92. The conductor 58 is coupled to the electrically heated catalyst 30 and selectively coupled to the switch 90.

In particular, when the switching device 50 is in the first operational state, the first switch 90 is electrically coupled in series between the first positive terminal 70 of the first battery 40 and the second positive terminal 80 of the second battery 42, and the second switch 92 is electrically coupled in series between the first negative terminal 72 of the first battery 40 and the second negative terminal 82 of the second battery 42. Alternately, when the switching device 50 is in the second operational state, the first switch 90 is electrically coupled in series to the first positive terminal 70 of the first battery 40 and the electrically heated catalyst 30, and the second switch 92 is electrically coupled in series between the first negative terminal 72 of the first battery 40 and the second positive terminal 80 of the second battery 42.

As shown, the vehicle electrical loads 33 are connected to the second positive terminal 80 and the second negative terminals 82 of the second battery 42 via the conductors 56, 57, respectively.

The temperature sensor 59 is configured to generate a signal indicative of a temperature level of exhaust gases flowing through the electrically heated catalyst 30 which is further indicative of a temperature level of the catalyst 30. The temperature sensor 59 is disposed proximate to the catalyst 30 and communicates with the controller 60.

The controller 60 is configured to control operation of the generator 39, the switching device 50, and the electrically heated catalyst 30, as will be explained in greater detail below. In one exemplary embodiment, the controller 60 is a microprocessor. However, in alternative embodiment, the controller 60 could be a solid-state circuit.

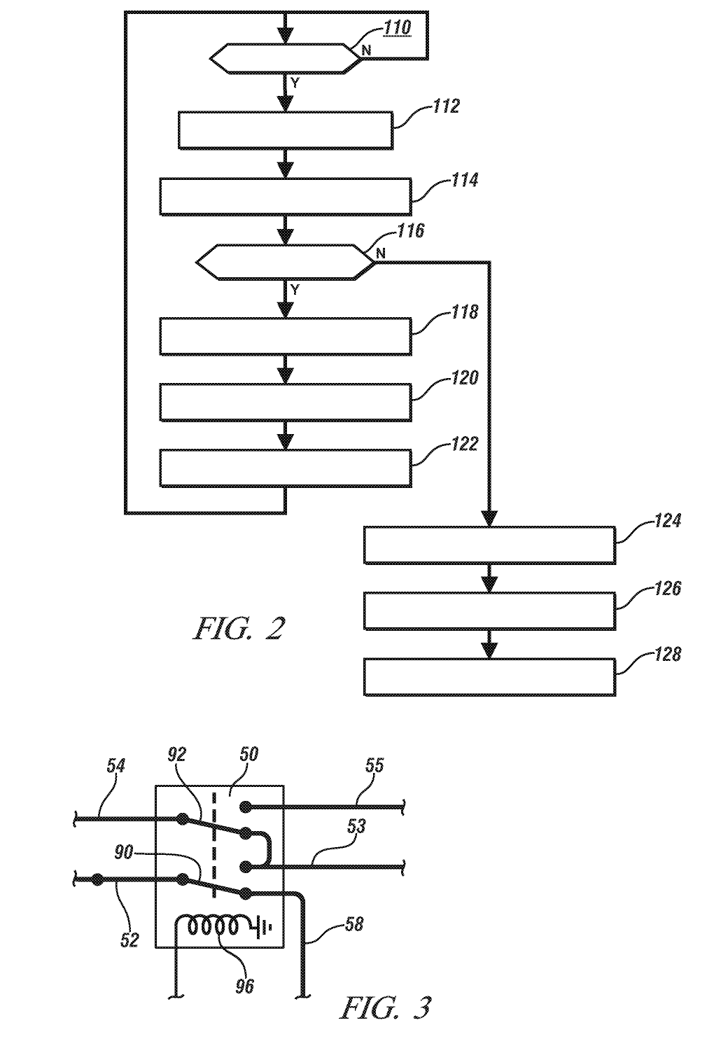

Referring to FIG. 2, a method for energizing the electrically heated catalyst 30 in accordance with another exemplary embodiment is provided.

At step 110, the controller 60 makes a determination as to whether the vehicle engine 20 is operating. If the value of step 110 equals “yes”, the method advances to step 112. Otherwise, the method returns to step 110.

At step 112, the first battery 40 outputs a first voltage and the second battery 42 outputs a second voltage.

At step 114, the temperature sensor 59 generates a temperature signal indicative of a temperature level of exhaust gases in the electrically heated catalyst 30 upstream of the oxidation catalyst 32, which is received by the controller 60.

At step 116, the controller 60 makes a determination as to whether the temperature of exhaust gases in the electrically heated catalyst 30 are less than a threshold temperature value. If the value of step 116 equals “yes”, the method advances to step 118. Otherwise, the method advances to step 124.

At step 118, the controller 60 sends a first control message to a generator 39 to induce the generator 39 to output a third voltage. The third voltage is substantially equal to a sum of the first voltage and the second voltage. In one exemplary embodiment, the third voltage is 24 volts.

At step 120, the controller 60 generates a first signal to induce a switching device 50 to transition from a first operational state where the first and second batteries 40, 42 are coupled in parallel to one another to a second operational state where the first and second batteries 40, 42 are coupled in series to one another.

At step 122, the generator 39 supplies the third voltage to the first battery to charge the first and second batteries 40, 42, and supplies the third voltage to the electrically heated catalyst 30 to induce the electrically heated catalyst 30 to heat exhaust gases upstream of the oxidation catalyst 32, when the first and second batteries 40, 42 are connected in series to one another. After step 122, method returns to step 110.

Referring again to step 116, if the value of step 116 equals “no” indicating that the temperature of exhaust gases in the electrically heated catalyst 30 are greater than or equal to the threshold temperature value, the method advances to step 124.

At step 124, the controller 60 sends a second control message to the generator 39 to induce the generator 39 to stop outputting the third voltage.

At step 126, the controller 60 generates a second signal to induce the switching device 50 to transition from the second operational state where the first and second batteries 40, 42 are coupled in series to one another to the first operational state where the first and second batteries 40, 42 are coupled in parallel to one another.

At step 128, the controller 60 sends a third control message to the generator 39 to induce the generator 39 to output a fourth voltage. The fourth voltage is equal to the first voltage. In one exemplary embodiment, the first and fourth voltages are 12 volts.

The power system and method for energizing the electrically heated catalyst provides a substantial advantage over other systems and methods. In particular, the power system and method provide a technical effect of simultaneously supplying a voltage to charge two batteries and to energize the electrically heated catalyst of a vehicle.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

What is claimed is:

1. A power system for energizing an electrically heated catalyst, the electrically heated catalyst being disposed upstream of an oxidation catalyst, the power system comprising:
a first battery configured to output a first voltage;
a second battery configured to output a second voltage;
a switching device coupled between the first and second batteries, the switching device having a first operational state such that the first and second batteries are coupled in series to one another, and the switching device having a second operational state such that the first and second batteries are coupled in parallel to one another; and
a generator coupled to the first battery, and when the switching device is in the second operational state the generator supplies a third voltage to the first battery to charge the first and second batteries, and supplies the third voltage to the electrically heated catalyst such that the electrically heated catalyst heats exhaust gases upstream of the oxidation catalyst.

2. The power system of claim 1, wherein the third voltage is substantially equal to a sum of the first voltage and the second voltage.

3. The power system of claim 1, further comprising a controller operably communicating with the switching device, the controller configured to generate a first signal to induce the switching device to have the first operational state, the controller further configured to generate a second signal to induce the switching device to have the second operational state.

4. The power system of claim 3, further comprising a temperature sensor disposed proximate to the electrically heated catalyst, the temperature sensor configured to generate a temperature signal indicative of a temperature level of the exhaust gases.

5. The power system of claim 4, wherein the controller is further configured to generate the second signal to induce the switching device to have the second operational state when the temperature level of the exhaust gases is less than a first threshold temperature value.

6. The power system of claim 5, wherein the controller is further configured to generate the first signal to induce the switching device to have the first operational state when the temperature level of the exhaust gases is greater than the first threshold temperature value.

7. The power system of claim 1, wherein the switching device comprises a double-pole double-throw relay device having a first switch and a second switch therein.

8. The power system of claim 7, wherein the first battery has a first positive terminal and a first negative terminal, and the second battery has a second positive terminal and a second negative terminal, and when the switching device is in the second operational state, the first switch is electrically coupled in series between the first positive terminal of the first battery and the electrically heated catalyst, and the second switch is electrically coupled in series between the first negative terminal of the first battery and the second positive terminal of the second battery.

9. The power system of claim 8, wherein when the switching device is in the first operational state, the first switch is electrically coupled in series between the first positive terminal of the first battery and the second positive terminal of the second battery, and the second switch is electrically coupled in series between the first negative terminal of the first battery and the second negative terminal of the second battery.

10. The power system of claim 1, wherein the first and second voltages are 12 volts, and the third voltage is 24 volts.

11. A method for energizing an electrically heated catalyst, the electrically heated catalyst being disposed upstream of an oxidation catalyst, comprising:
generating a first signal to induce a switching device to transition from a first operational state where first and second batteries are coupled in parallel to one another to a second operational state where the first and second batteries are coupled in series to one another, utilizing a controller; and
supplying a voltage from a generator to the first battery to charge the first and second batteries, and supplying the voltage to the electrically heated catalyst to induce the electrically heated catalyst to heat exhaust gases upstream of the oxidation catalyst, when the first and second batteries are connected in series to one another.

12. The method of claim 11, further comprising generating a temperature signal indicative of a temperature level of exhaust gases flowing through the electrically heated catalyst utilizing a temperature sensor.

13. The method of claim 12, further comprising generating the first signal when the temperature level of the exhaust gases is less than a first threshold temperature value, utilizing the controller.

14. The method of claim 12, further comprising:
removing the voltage from the generator to the first battery and the electrically heated catalyst; and
generating a second signal to induce the switching device to transition from the second operational state to the first operational state to connect the first and second batteries in parallel with one another when the temperature level of the exhaust gases is greater than or equal to a first threshold temperature value, utilizing the controller.

15. The method of claim 11, wherein the voltage is 24 volts.
